(19) United States
(12) Patent Application Publication
(10) Pub. No.: US 2005/0279202 A1
(43) Pub. Date: Dec. 22, 2005

(54) Punching appartus

(76) Inventor: Pei-Yuan Lee, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 11/141,694

(22) Filed: May 31, 2005

(30) Foreign Application Priority Data
Jun. 17, 2004 (TW) 093117506

(51) Int. Cl. B26D 5/08

(52) U.S. Cl. 83/622; 83/588

(57) ABSTRACT

A punching apparatus includes a platform for placing thereon an object to be punched, a rail body coupled to the platform and having two oppositely arranged rail elements and a cutting-pin receiving space between the two rail elements, a cutting tool including a plurality of cutting pins movably installed in the cutting-pin receiving space, a sliding member slidable along the rail body, and a first sustaining member disposed between the rail elements and carried by the sliding member for sequentially forcing the cutting pins to protrude toward the platform, thereby creating through holes in the object.

### FIELD OF THE INVENTION

The present invention relates to a punching apparatus and more particularly to a punching apparatus making serial punching.

### BACKGROUND OF THE INVENTION

A conventional manual punching apparatus for creating through holes in an object is illustrated in FIG. 1. The user exerts a force on a lever 11 to pivot the lever 11 as indicated by the arrow, thereby moving a plurality of punching pins (not shown) downwards to simultaneously penetrate through the object 10 placed on a platform 12. Since a plurality of punching pins are operated at the same time to create a plurality of holes, lots of efforts have to be made. In addition, for stabilizing the machine when pushing the lever 11 downwards, the platform 12 should be large enough so as to occupy much space on the working table.

For solving the bulky and exertive problems, a punching apparatus making serial punching was developed, as disclosed in U.S. patent application Ser. No. 5,463,922 and shown in FIG. 2A. In the punching apparatus, a sliding member 21 is moved along with a rail 20 while pushing the punching pins 22 sequentially so as to create holes on the object 10. Since the punching operation is performed by simply moving the sliding member 21 and only one or two punching pins 22 will be pushed at the same time, as shown in FIG. 2B, the punching operation can be performed with little effort. Moreover, since a sliding force rather than a pushing force is exerted, no large platform is required for stabilizing the machine. The punching apparatus of FIG. 2A, on the other hand, suffers from a weak sustaining structure of the punching pin 22, as shown in FIG. 2C.

In this punching apparatus, a sustaining bar 220 is coupled to and crossing each pin body 221. The sustaining bar 220 is sequentially guided up and down with the movement of the sliding member 21. When the sustaining bar 220 is pressed down by the sliding member 21, it transmits the corresponding pin body 221 to move downward, thereby punching through the object 10. Afterwards, the sustaining bar 220 is lifted up to transmit the corresponding pin body 221 to move back to the standby position. As a result, the joint of the sustaining bar 220 and the pin body 221 will be greatly subjected to forcible action and thus subject to distortion or damage.

### SUMMARY OF THE INVENTION

Therefore, the present invention provides a punching apparatus involving in minimized forcible action on the sustaining bar.

The present invention relates to a punching apparatus, which comprises a platform for placing thereon an object to be punched; a rail body coupled to the platform and having two oppositely arranged rail elements and a cutting-pin receiving space between the two rail elements; a cutting tool including a plurality of cutting pins movably installed in the cutting-pin receiving space; a sliding member slidable along the rail body; and a first sustaining member disposed between the rail elements and carried by the sliding member for sequentially forcing the cutting pins to protrude toward the platform, thereby creating through holes in the object.

In an embodiment, the rail body includes guiding elements arranged at the rail elements for guiding the movement of the cutting pin in the cutting-pin receiving space.

In an embodiment, the guiding elements are guiding slots symmetrically arranged in the rail elements and elongated in a direction conforming to the moving direction of the cutting pins.

In an embodiment, each of the cutting pins is cross-shaped and includes a pin body for punching through the object and a traverse bar having two ends thereof protruding from and moving in opposite two of the guiding slots for guiding the pin body between a standby position and a punching-through position, and the first sustaining member directly depresses and moves the pin body from the standby position to the punching-through position.

In an embodiment, the pinching apparatus further comprises a second sustaining member for pushing the traverse bar up so as to retract the pin body from the punching-through position to the standby position after the pin body has been depressed by the first sustaining member to punch through the object. Each of the two guiding opposite slots preferably has a width approximating to a diameter of the traverse bar engaging therewith so as to exhibit a certain level of frictional force between the traverse bar and walls of the two opposite guiding slots, thereby stopping the traverse bar from arbitrarily moving in the two opposite slots before being pushed by the first or second sustaining member.

In an embodiment, the second sustaining member includes a spring sleeved on the pin body under the traverse bar, wherein the spring is compressed by the traverse bar when the first sustaining member depresses and moves the pin body from the standby position to the punching-through position and restoring to push the traverse bar up when the force for protruding the cutting pins toward the platform is released.

In an embodiment, the pinching apparatus further comprises a second sustaining member coupled to the sliding member and disposed downstream of the first sustaining member in a first sliding direction of the sliding member on the rail body for sequentially forcing the cutting pins to retract away from the platform.

In an embodiment, the pinching apparatus further comprises a third sustaining member coupled to the sliding member and symmetrically arranged relative to the first sustaining member so that the third sustaining member is disposed downstream of the first sustaining member when the sliding member moves along the rail body in a second sliding direction opposite to the first sliding direction, thereby sequentially forcing the cutting pins to retract away from the platform.

In an embodiment, each of the second and third sustaining members has a surface of an inclined curve for gradually pushing the cutting pins up. Alternatively, each of the second and third sustaining members has a surface of an inclined plane for gradually pushing the cutting pins up.

In an embodiment, the punching apparatus further comprises a second sustaining member coupled to the cutting pins for forcing the cutting pins to retract away from the platform as soon as the force for protruding the cutting pins toward the platform is released. For example, the second sustaining member is a spring element.

In an embodiment, the first sustaining member includes a handle disposed at an exterior side of the sliding member for exerting thereon a depressing force; a roller rotatably disposed at an interior side of the sliding member and sustaining against the top surface of the cutting pins for sequentially forcing the cutting pins to protrude toward the platform; and a shaft penetrating through the roller and the sliding member and coupled to the handle for depressing the roller against the cutting pins when the depressing force is exerted on the handle.

Preferably, the first sustaining member further comprises a resilient element interfacing the handle with the sliding member, and the resilient is deformable in response to the depressing force exerted on the handle and restoring to retract the roller from the cutting pins when the depressing force is released from the handle. The resilient element, for example, is a spring element.

In an embodiment, the sliding member has a slot elongated in a direction conforming to a moving direction of the handle and roller so that the sliding member does not move with the handle and roller in response to the depressing force.

The present invention also relates to a punching apparatus, which comprises a rail body arranged therein and exposed therefrom a series of cutting pins; a sliding member slidable along the rail body; a handle disposed at an exterior side of the sliding member for exerting thereon a depressing force; and a roller rotatably disposed at an interior side of the sliding member and sustaining against the top surface of said cutting pins for sequentially forcing the cutting pins to protrude toward an object to be punched in response to the depressing force.

### BRIEF DESCRIPTION OF THE DRAWINGS

The present invention may best be understood through the following description with reference to the accompanying drawings, in which:

FIG. 1 is a schematic top perspective view showing a conventional punching apparatus;

FIG. 2A is a schematic top perspective view showing another conventional punching apparatus;

FIG. 2B is a schematic side view showing the punching mechanism of the punching apparatus of FIG. 2A;

FIG. 2C is a schematic diagram showing one of the punching pins of the punching apparatus of FIG. 2A;

FIG. 3A is a schematic top-left perspective view showing a first embodiment of a punching apparatus according to the present invention;

FIG. 3B is a schematic top-front perspective view of the punching apparatus of FIG. 3A;

FIG. 4 is a schematic top-left perspective view showing a second embodiment of a punching apparatus according to the present invention; and

FIG. 5 is a schematic cross-sectional view showing a third embodiment of a punching apparatus according to the present invention.

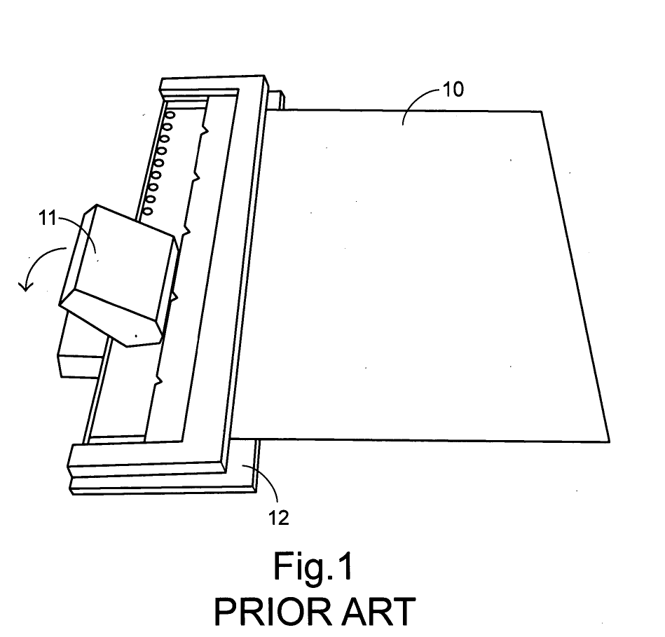

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

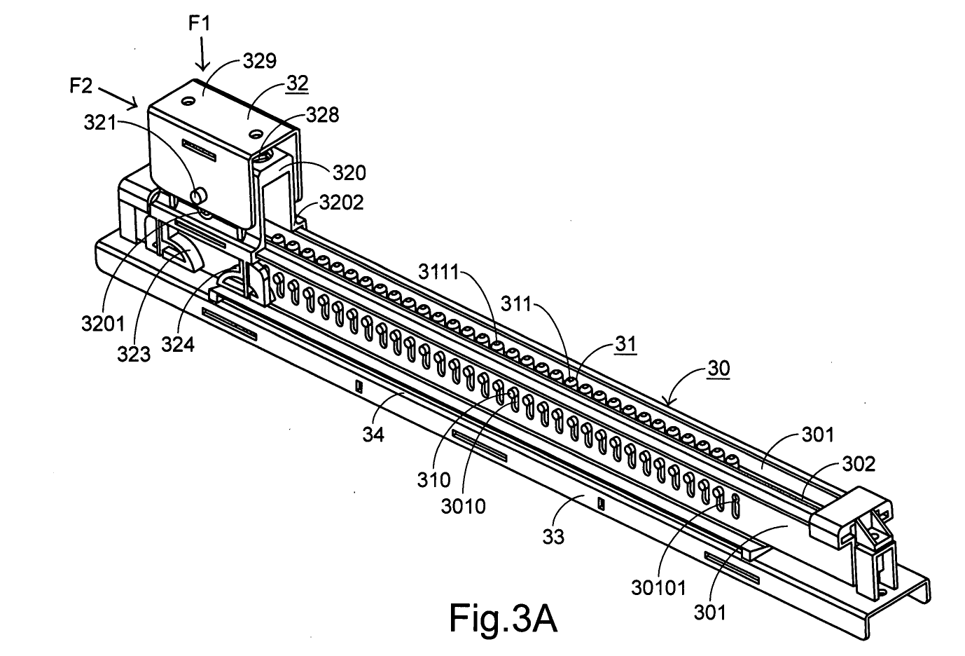

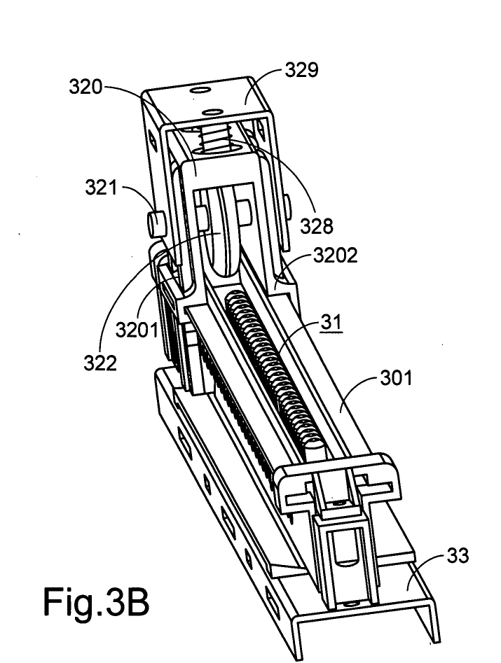

Please refer to FIG. 3A and 3B. A punching apparatus according to an embodiment of the present invention includes a rail body 30, a cutting tool 31, a sliding assembly 32 and a platform 33. For punching holes in an object (not shown), e.g. paper, the object is fed into the platform 33 from the entrance 34, and the sliding assembly 32 is moved along the rail body 30. While the sliding assembly 32 slides along the rail body 30, the cutting tool 31 is forced down to punch through the object.

The rail body 30 includes two oppositely arranged rail elements 301, i.e. rail walls, and has a cutting-pin receiving space 302 between the rail elements 301. The sliding member 320 has two hooked walls 3202 for engaging with and sliding along the two rail elements 301, respectively. Outside the sliding member 320, a handle 329 is arranged. Further, a roller 322 is disposed inside the sliding member 320 and a spring 328 is disposed between the sliding member 320 and the handle 329. The sliding member 320 has elongated slots 3201 arranged in the hooked walls 3202 so that a shaft 321 can penetrate through the roller 322 and the elongated slots 3201 of the sliding member 320 and coupled to the handle 329. In this configuration, the roller 322 can be transmitted down to sustain against the top of the cutting pins 311 of the cutting tool 31 when a depressing force F1 is exerted on the handle 329. Since the elongated slots 3201 extends in a direction conforming to a moving direction of the handle 329 and roller 322, the sliding member 320 does not move downwards with the handle 329 and roller 322.

When the depressing force F1 is exerted on the handle 329, the roller 322 is transmitted down via the shaft 321 so as to sustain against and push down one or two of the cutting pins 311, depending on the size of the roller 322. The pushed cutting pin protrudes toward the platform 33 so as to punch through the object to create a hole. Then, the roller 322 rotates and moves with the sliding member 320 to depress another cutting pin 311 to create another hole in response to a forwardly moving force F2 exerted on the handle 329. Therefore, a series of through holes can be sequentially created in the object in the journey of the roller 322 from one end of the rail body 30 to the other. After the journey ends, the depressing force F1 and forwardly moving force F2 are removed. Meanwhile, the previously compressed spring 328 due to the depressing force F1 restores to push the handle 329 up. Accordingly, the roller 322 is also transmitted up via the shaft 321 so as to separate from the cutting pins 311.

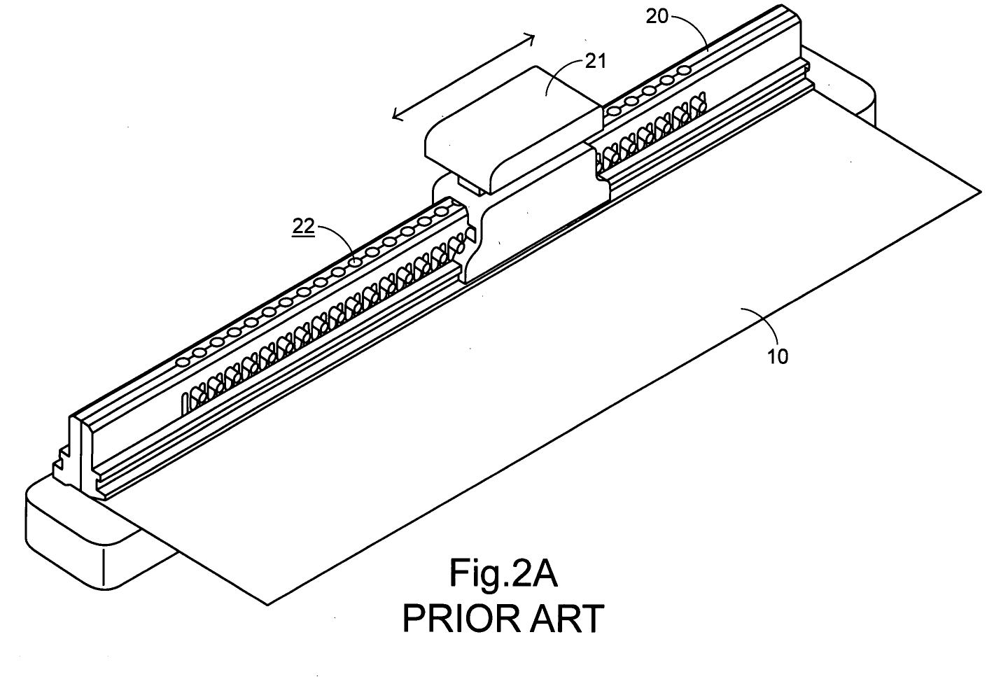

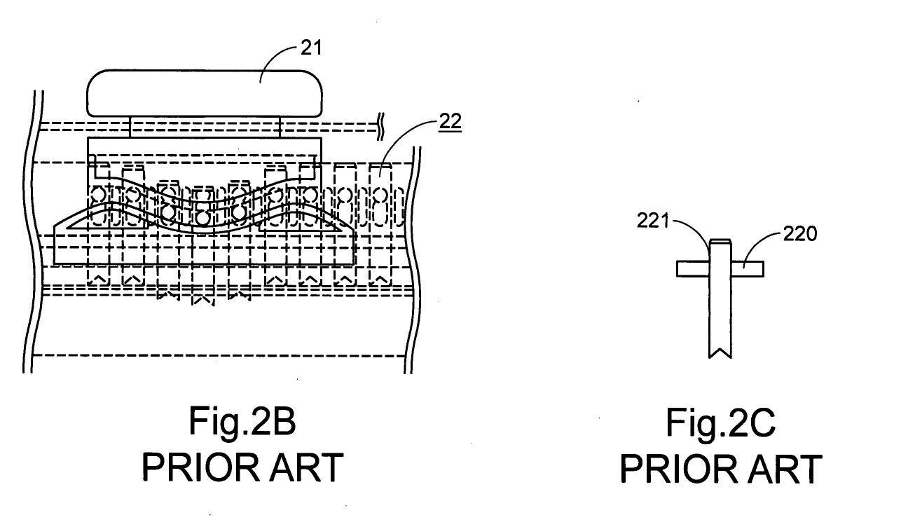

During the journey of the roller 322 from one end of the rail body 30 to the other, once the roller 322 moves forwards, the preceding pushed cutting pin 311 in a punching-through position is released and should be pushed back to a standby position. For achieving this purpose, a sustaining member 323 coupled to the sliding member 320 and arranged downstream of the roller 322 is provided. In this embodiment, each of the cutting pins 311 has a shape similar to that shown in FIG. 2C and includes a pin body 3111 and a traverse bar 310. The sustaining member 323 has a surface of inclined curve. It is the top surface of the pin body 3111 directly depressed by the roller 322 to move the cutting pin 311 to the punching-through position. On the other hand, it is the traverse bar 310 directly pushed up by the sustaining element 323 to return the cutting pin 311 to the standby position. Preferably, the sliding assembly 32 further includes another sustaining member 324 coupled to the sliding member 320 and symmetric to the sustaining member 323 relative to the roller 322. In this way, another punching operation can be performed when the sliding assembly 32 moves reversely.

In the two rail elements 301, pairs of guiding slots 3010 are arranged. Two ends of the traverse bar 220 penetrate through a pair of the guiding slots 3010 and protrude from the two rail elements 301, respectively. Each of the guiding slots 3010 preferably has a neck portion 30101 whose width approximates to a diameter of the traverse bar 310 engaging therewith so as to exhibit a certain level of frictional force between the traverse bar 310 and the neck portion 30101, thereby stopping the traverse bar 310 from arbitrarily moving in the guiding slot 3010 before being pushed by the roller 322. When the roller 322 sustains against the top surface of one of the pin bodies 3111 and forces that cutting pin 311 down, the traverse bar 310 of that cutting pin 311 will be forced through the neck portion 30101 of the corresponding guiding slots 3010 and move down to punch through the object. On the other hand, when the traverse bar 310 is pushed up to retract the pin body 311 away from the platform 33 by the sustaining member 323, the cutting pin 311 can be fixed at the standby position with the traverse bar 310 stuck by the neck portion 30101.

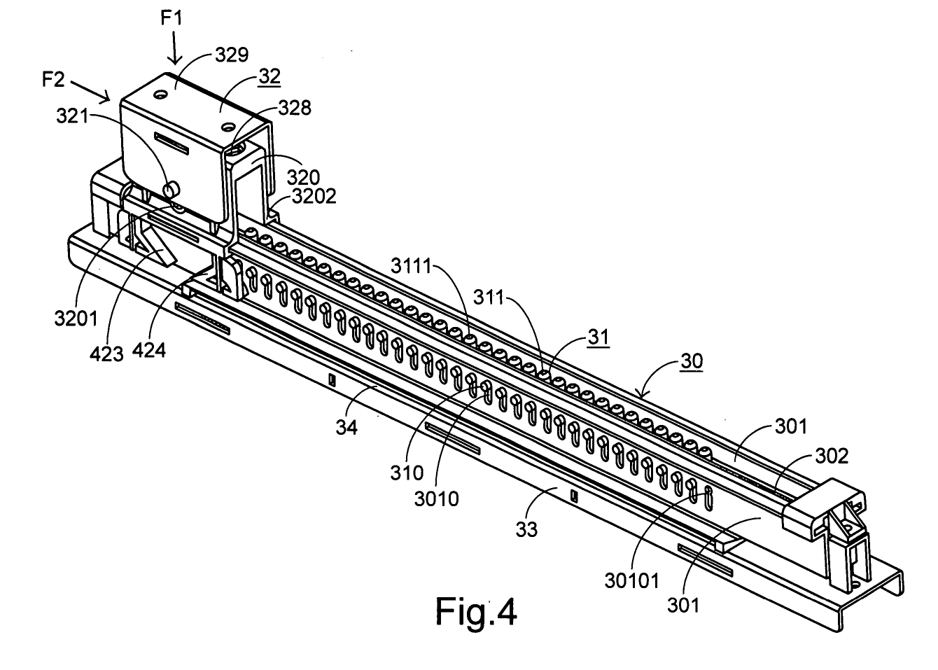

The sustaining members 323 and 324 have curved surfaces in the above-mentioned embodiment. Alternatively, the surfaces 423 and 424, as shown in FIG. 4, can also be inclined planes to achieve the similar purpose.

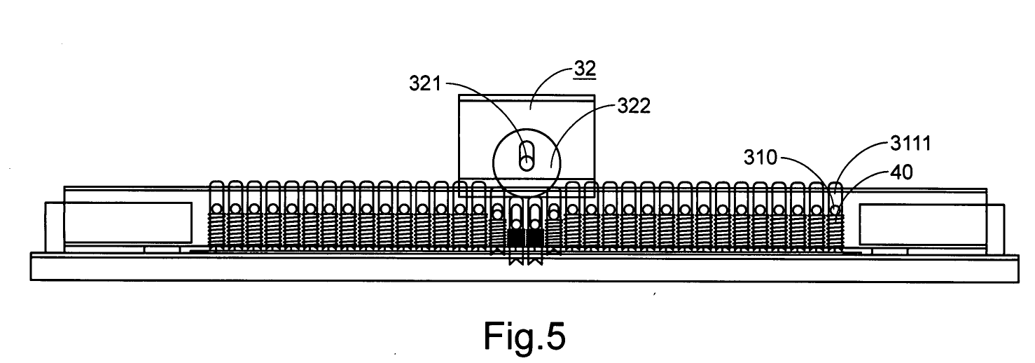

In a further embodiment with reference to FIG. 5, the sustaining members 323 (423) and 324 (424) illustrated above can be omitted. In stead, a spring 40 is sleeved on the pin body 3111 under the traverse bar 310 of each cutting pin 311. When the roller 322 sustains against the top surface of one of the pin bodies 3111 and forces that cutting pin 311 down, the spring 40 is compressed. Once the roller 322 moves forwards, the preceding pushed cutting pin 311 is released. Thus, the spring 40 restores to push the traverse bar 310 up, thereby recovering the cutting pin 311 from the punching-through position to the standby position.

It is understood from the above embodiments that the present invention involves in minimized forcible action by exerting a depressing force on the top surfaces of the cutting pins. Furthermore, the punching-pin moving operation is made smooth due to implementation with a rotating roller.

While the invention has been described in terms of what are presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and structures.

1. A punching apparatus, comprising:
a platform for placing thereon an object to be punched;
a rail body coupled to said platform and having two oppositely arranged rail elements and a cutting-pin receiving space between said two rail elements;
a cutting tool including a plurality of cutting pins movably installed in said cutting-pin receiving space;
a sliding member slidable along said rail body; and
a first sustaining member disposed between said rail elements and carried by said sliding member for sequentially forcing said cutting pins to protrude toward said platform, thereby creating through holes in said object.

2. The punching apparatus according to claim 1 wherein said rail body includes guiding elements arranged at said rail elements for guiding the movement of said cutting pin in said cutting-pin receiving space.

3. The punching apparatus according to claim 2 wherein said guiding elements are guiding slots symmetrically arranged in said rail elements and elongated in a direction conforming to the moving direction of said cutting pins.

4. The punching apparatus according to claim 3 wherein each of said cutting pins is cross-shaped and includes a pin body for punching through said object and a traverse bar having two ends thereof protruding from and moving in opposite two of said guiding slots for guiding said pin body between a standby position and a punching-through position, and said first sustaining member directly depresses and moves said pin body from said standby position to said punching-through position.

5. The punching apparatus according to claim 4 further comprising a second sustaining member for pushing said traverse bar up so as to retract said pin body from said punching-through position to said standby position after said pin body has been depressed by said first sustaining member to punch through said object.

6. The punching apparatus according to claim 5 wherein each of said two opposite guiding slots has a width approximating to a diameter of said traverse bar engaging therewith so as to exhibit a certain level of frictional force between said traverse bar and walls of said two opposite guiding slots, thereby stopping said traverse bar from arbitrarily moving in said two opposite guiding slots before being pushed by said first or second sustaining member.

7. The punching apparatus according to claim 5 wherein said second sustaining member includes a spring sleeved on said pin body under said traverse bar, wherein said spring is compressed by said traverse bar when said first sustaining member depresses and moves said pin body from said standby position to said punching-through position and restoring to push said traverse bar up when the force for protruding said cutting pins toward said platform is released.

8. The punching apparatus according to claim 1 further comprising a second sustaining member coupled to said sliding member and disposed downstream of said first sustaining member in a first sliding direction of said sliding member on said rail body for sequentially forcing said cutting pins to retract away from said platform.

9. The punching apparatus according to claim 8 further comprising a third sustaining member coupled to said sliding member and symmetrically arranged relative to said first sustaining member so that said third sustaining member is disposed downstream of said first sustaining member when said sliding member moves along said rail body in a second sliding direction opposite to said first sliding direction, thereby sequentially forcing said cutting pins to retract away from said platform.

10. The punching apparatus according to claim 9 wherein each of said second and third sustaining members has a surface of an inclined curve for gradually pushing said cutting pins up.

11. The punching apparatus according to claim 9 wherein each of said second and third sustaining members has a surface of an inclined plane for gradually pushing said cutting pins up.

12. The punching apparatus according to claim 1 further comprising a second sustaining member coupled to said cutting pins for forcing said cutting pins to retract away from said platform as soon as the force for protruding said cutting pins toward said platform is released.

13. The punching apparatus according to claim 12 wherein said second sustaining member is a spring element.

14. The punching apparatus according to claim 1 wherein said first sustaining member includes:
a handle disposed at an exterior side of said sliding member for exerting thereon a depressing force;
a roller rotatably disposed at an interior side of said sliding member and sustaining against the top surface of said cutting pins for sequentially forcing said cutting pins to protrude toward said platform; and
a shaft penetrating through said roller and said sliding member and coupled to said handle for depressing said roller against said cutting pins when said depressing force is exerted on said handle.

15. The punching apparatus according to claim 14 wherein said first sustaining member further comprises a resilient element interfacing said handle with said sliding member, and said resilient is deformable in response to said depressing force exerted on said handle and restoring to retract said roller from said cutting pins when said depressing force is released from said handle.

16. The punching apparatus according to claim 15 wherein said resilient element is a spring element.

17. The punching apparatus according to claim 14 wherein said sliding member has a slot penetrating therethrough said shaft and elongated in a direction conforming to a moving direction of said handle and roller.

18. A punching apparatus, comprising:
a rail body arranged therein and exposed therefrom a series of cutting pins;
a sliding member slidable along said rail body;
a handle disposed at an exterior side of said sliding member for exerting thereon a depressing force; and
a roller rotatably disposed at an interior side of said sliding member and sustaining against the top surface of said cutting pins for sequentially forcing said cutting pins to protrude toward an object to be punched in response to said depressing force.

19. The punching apparatus according to claim 18 further comprising a shaft penetrating through said roller and said sliding member and coupled to said handle for depressing said roller against said cutting pins when said depressing force is exerted on said handle.

20. The punching apparatus according to claim 19 wherein said sliding member has a slot penetrating therethrough said shaft and elongated in a direction conforming to a moving direction of said handle and roller.
